(19) United States
(12) Patent Application Publication
(10) Pub. No.: US 2011/0024204 A1
(43) Pub. Date: Feb. 3, 2011

(54) CONSTRUCTION VEHICLE WITH A SPLIT HYDRAULIC HOLDING UNIT

(75) Inventor: Gilles Florean, Belley (FR)

Correspondence Address: WRB-IP LLP, 801 N. Pitt Street, Suite 123, ALEXANDRIA, VA, 22314, US

(73) Assignee: Volvo Construction Equipment AB, Eskilstuna (SE)

(21) Appl. No.: 12/935,607

(22) PCT Filed: Apr. 14, 2008
(86) PCT No.: PCT/IB08/02290

§ 371 Date: Sep. 30, 2010

(51) Int. Cl. B60K 25/00

(52) U.S. Cl. 180/53.8

(57) ABSTRACT

A construction vehicle includes a wheeled chassis supporting at least one article of work equipment, hydraulically actuated, a hydraulic power unit driving the work equipment including a hydraulic pump connected to an hydraulic liquid holding unit and to a hydraulic control unit distributing hydraulic power the work equipment, a driver's compartment including a driver's floor, wherein the hydraulic liquid holding unit includes a main hydraulic reservoir which is disposed on the chassis at a level lower than the driver's floor level, and at least one auxiliary hydraulic reservoir which is disposed on the chassis at a level above the driver's floor level.

### BACKGROUND AND SUMMARY

The invention relates to the field of engineering or construction vehicles. It concerns more precisely construction vehicles equipped with at least one work equipment hydraulically actuated by a hydraulic power unit. It relates more specifically to the design of a hydraulically liquid holding unit being a part of the hydraulic power unit.

A construction vehicle generally comprises a wheeled chassis supporting at least one work equipment hydraulically actuated. The construction vehicle comprises also a hydraulic power unit driving the work equipment. Therefore, the hydraulic power unit comprises at least a hydraulic pump connected to a hydraulic reservoir and to a hydraulic control unit distributing hydraulic power to the work equipment. The power of such construction vehicle is provided by a combustion engine driving the vehicle as well as the hydraulic pump. The construction vehicle comprises also a driver compartment either open or closed.

As the work equipment may be used as the construction vehicle rests on a slope or an inclined ground, it is important to make sure that the hydraulic pump is always supplied with hydraulic liquid whatever are the working positions of the construction vehicle. It is also important to avoid any air suction by the hydraulic pump while the work equipment is used as air bubbles in the hydraulic circuit might induce dangerous moves of the work equipment. In order to make sure that such working conditions are always maintained, the hydraulic liquid reservoir is generally on a high part of the chassis and, more particularly, at a higher level than the hydraulic pump and is connected to it by a main intake circuit going down from the hydraulic liquid reservoir to the hydraulic pump.

If such design prevents any air suction its main drawback is to situate the hydraulic liquid reservoir far away from the other hydraulic components, more particularly the hydraulic pump and the hydraulic control unit. This distance induces high friction losses in the hydraulic circuit which minors the hydraulic pump performances and induces jerks in the movements of the work equipment.

Therefore, the need exists for a new design of the hydraulic power unit in order to achieve better hydraulic performances while keeping safe working conditions by avoiding any air suction in running configuration of the construction vehicle.

According to an aspect of the present invention, a construction vehicle is provided comprising:
a wheeled chassis supporting at least one work equipment hydraulically actuated;
a hydraulic power unit driving the work equipment comprising a hydraulic pump connected to a hydraulic, liquid holding unit and to a hydraulic control unit distributing hydraulic power the work equipment;
a combustion engine driving the vehicle and the hydraulic pump;
a driver's compartment comprising a driver's floor, wherein the hydraulic, liquid holding unit comprises:
a main hydraulic reservoir which is disposed on the chassis at a level lower than the driver's floor level and which is connected by a main intake circuit to the hydraulic pump and by a main return circuit to the hydraulic control unit;
and at least one auxiliary hydraulic reservoir which is disposed on the chassis at a level upper than the driver's floor level and which is connected to the main hydraulic reservoir by a down main circuit and by an air bleed circuit.

By splitting the hydraulic liquid holding unit into a main hydraulic reservoir and an auxiliary hydraulic reservoir, it is possible to situate the main hydraulic, reservoir nearer the hydraulic pump and the hydraulic control unit than it was possible with prior art design while the auxiliary hydraulic reservoir may be situated at a level high enough to maintain a hydraulic liquid column high enough to avoid any air suction in all the normal working configuration of the construction vehicle.

According to an aspect of the invention, the auxiliary hydraulic reservoir is situated in front of driver's compartment. Such position of the auxiliary hydraulic reservoir facilitates the filling or refilling of hydraulic liquid holding unit and is also particularly suitable for construction vehicle equipped, in a front region, with a loading equipment and, in a rear region, with a shovel equipment such construction vehicle being generally referred as backhoe-loader.

According to another aspect of the invention, the chassis comprises two elongated frame members and the main hydraulic reservoir is situated between the two elongated frame members.

According to a further aspect of the invention, the chassis comprises two front loader support posts, the auxiliary hydraulic reservoir being situated between the support posts.

According to an embodiment of the invention, the main hydraulic reservoir comprises a roof which is inclined at a predetermined angle to the horizontal when the vehicle rests on a horizontal ground, the air bleed circuit being connected to the main hydraulic reservoir in an upper part of the roof. This inclination of the roof of the main hydraulic reservoir accelerates degassing of the hydraulic liquid when the hydraulic pump runs for the first time while the construction vehicle is for example prepared for shipment.

According to an aspect of this embodiment of the invention, the predetermined angle is superior or equal to 3° and preferably superior or equal to 5°. Such angle value prevents the air bubbles from sticking to the roof of the main hydraulic reservoir.

According to another aspect of the embodiment, the intake circuit is connected to the main hydraulic reservoir under a lower part of the roof. This aspect of the invention prevents from air suction during the degassing phase and allows a reduction of the running time necessary for eliminating all air bubbles from the hydraulic circuit.

According to still another aspect of this embodiment, the roof has a maximal length and maximal width which both are superior or equal to a maximal height of the main hydraulic reservoir. This particular aspect of the invention permits to have, for a given capacity of the main hydraulic reservoir, a free surface of the hydraulic liquid as extended as possible when the main hydraulic reservoir is not completely full of hydraulic liquid.

According to a further aspect of the invention, the main down circuit is connected to the main hydraulic reservoir above the connection of the intake circuit to the main hydraulic reservoir. This design shortens the flow path from the auxiliary reservoir to the hydraulic pump and prevents air suction when the hydraulic pump starts running or is working at a high flow rate.

According to an aspect of the invention, the main intake circuit is connected to the main hydraulic reservoir at a level upper than the level of an intake of the hydraulic pump when the construction vehicle is resting on a horizontal ground. This aspect of the invention guarantees hydraulic liquid height in the intake circuit and a good pump efficiency.

In order to preserve the pump efficiency and good working conditions, according to another aspect of the invention, the construction vehicle or the hydraulic power unit comprises a hydraulic liquid height between a normal filling level of the auxiliary hydraulic reservoir and an intake of the hydraulic pump, this hydraulic liquid height being greater than 500 mm, preferably greater than 650 mm and more preferably greater than 700 mm.

In order to allow a hydraulic liquid replacement consistent with a good functioning of the hydraulic, systems and affordable exploitation costs, according to an aspect of invention, the hydraulic liquid holding unit has a capacity superior or equal to a third of the total capacity of hydraulic liquid of the vehicle.

In order to provide near the hydraulic pump a hydraulic liquid quantity enough to feed the hydraulic pump when it starts running or when it works at high flow rates, according to another aspect of the invention, the main hydraulic reservoir has a capacity superior or equal to the volume of hydraulic liquid contained by the auxiliary hydraulic, reservoir when it is filed up to a normal filling level.

According to an aspect of the invention, the volume of hydraulic liquid contained by the auxiliary hydraulic reservoir when it is filed up to a normal filling level is superior or equal to a sixth of the total normal capacity of hydraulic liquid of the vehicle. This aspect of the invention permits to have an auxiliary hydraulic reservoir big enough to allow some overfilling of the hydraulic liquid unit.

According to another aspect of the invention, the main hydraulic reservoir has a capacity superior or equal to a sixth of the total normal capacity of hydraulic liquid of the vehicle.

According to a further aspect of the invention, it comprises a hydraulic liquid cooling unit having a cooling return circuit connected to the auxiliary hydraulic reservoir.

In order to reduce the friction losses and according to an aspect of the invention, the main return circuit has a length measured between an exit of a hydraulic filter and the main hydraulic reservoir less than 700 mm.

For the same reasons and according to an aspect of the invention, the connection of the main return circuit to the main hydraulic reservoir is situated at a distance of the connection of the main intake circuit to the main hydraulic circuit, said distance being greater than 400 mm.

In order to reduce the friction losses and according to an aspect of the invention, the main intake circuit has a length measured between a pump intake and the main hydraulic reservoir, said length being less than 400 mm and preferably less than 300 mm.

According to an aspect of the invention, the main hydraulic reservoir is connected to the chassis by vibration absorbers.

The various above aspects or embodiments of the invention may be combined in various ways with each others provided the combined aspects or embodiments are not incompatible or mutually exclusive.

### DESCRIPTION OF THE FIGURES

Other aspects and advantages of the present invention will be apparent from the following detailed description made in conjunction with the accompanying drawing illustrating schematically a non-limitative embodiment of the invention.

FIG. 1 is a overall side view of a construction vehicle according to an aspect of the invention being of the backhoe/loader or loader shovel type.

FIG. 2 is a schematic side view illustrating the hydraulic power unit.

FIG. 3 is a schematic perspective of the chassis of the construction vehicle illustrated on FIG. 1, showing more particularly the position of a main hydraulic, reservoir and an auxiliary hydraulic reservoir forming a hydraulic liquid holding unit.

FIG. 4 is a partial schematic perspective illustrating the main hydraulic reservoir and the hydraulic command unit of the construction vehicle illustrated on FIG. 1

Corresponding reference numbers indicate corresponding components in the various drawings.

### DETAILED DESCRIPTION

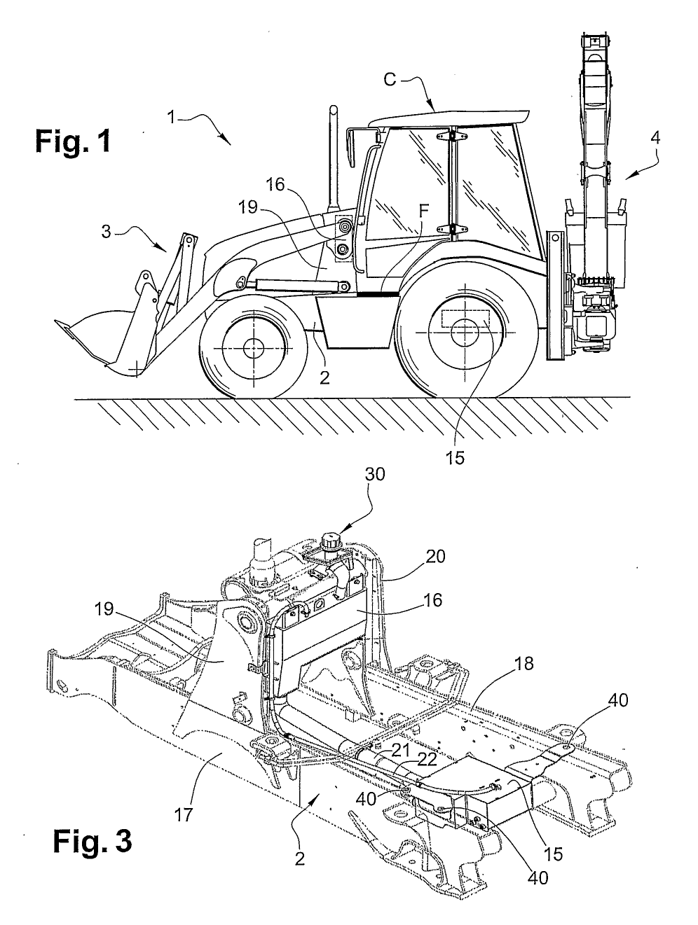

As stated previously, a construction vehicle according to an aspect of the invention, as illustrated on FIG. 1 and designated as a whole by reference number 1 comprises a wheel chassis 2 supporting at the front a work equipment 3 of the loader type and at the rear a work equipment 4 of the shovel or backhoe type.

The construction vehicle 1 comprises also a driver's compartment C fitting on the chassis 3 above the rear wheels. The driver's compartment C comprises a driver's floor F generally above the wheel axis.

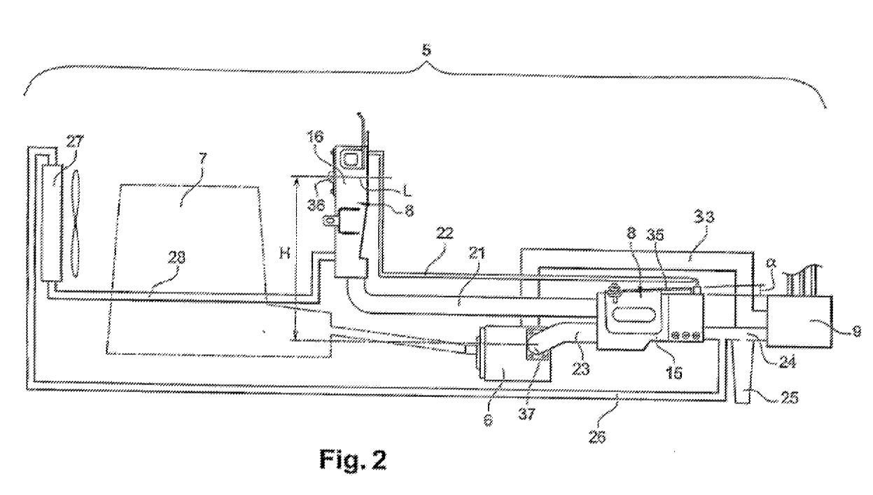

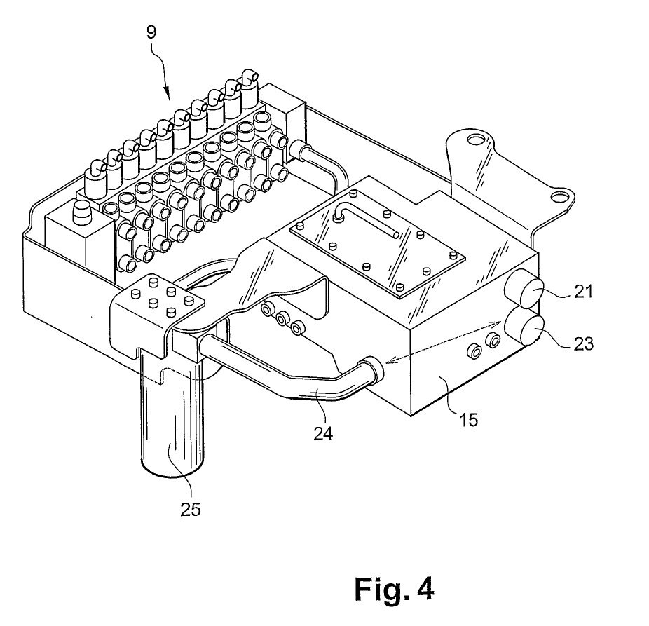

The work equipments 3, 4 are hydraulically actuated. Therefore, the construction vehicle 1 comprises a hydraulic power unit 5 as shown on FIG. 2.

The hydraulic power unit 5 comprises a hydraulic pump 6 which is driven by a combustion engine 7 which drives also the construction vehicle 1. The hydraulic pump 6 sucks the hydraulic liquid from a hydraulic holding unit 8 for feeding a hydraulic control unit 9 distributing hydraulic power at least to the work equipments 3 and 4.

According to an aspect of the invention, the hydraulic liquid holding unit 8 is split in at least two reservoirs: a main hydraulic reservoir 15 being disposed on the chassis at a level lower than the driver's floor F level and an auxiliary hydraulic reservoir 16 being disposed on the chassis 2 at a level upper than the level of the driver's floor F. According to the shown example, the chassis 2 comprises two elongated frame members 17 and 18, extending from the front to the rear of the vehicle and the main hydraulic reservoir is situated between the two elongated frame members 17 and 18 under the driver's compartment C. The main hydraulic reservoir 15 is connected to the chassis 2 by vibrations absorbers 40. Also on this shown example, the chassis 2 comprises two front loader support posts 19, 20 each extending up from an elongated frame member 17 or 18 in front of the driver's compartment C. The auxiliary hydraulic reservoir 16 is situated between those two front support posts 19 and 20. The bottom of the auxiliary hydraulic reservoir 16 is connected to the main hydraulic reservoir by a down main circuit 21. The top of the main hydraulic reservoir 15 is further connected by an air bleed circuit 22 to an upper part of the auxiliary hydraulic reservoir 16.

The main hydraulic reservoir 15 is also directly connected to the hydraulic pump 6 by a main intake circuit 23 which opens in the main hydraulic reservoir 15 under the connection of the main down circuit 21. The pump 6 is further connected by a main feed circuit 33 to the hydraulic control unit 9 which is connected to the main hydraulic reservoir 15 by a return circuit 24. The hydraulic control unit 9 is further connected by feeding lines and return lines not shown to the work equipments 3 and 4 as well to other hydraulic equipments. On the shown example the return circuit 24 comprises a hydraulic liquid filter 25 and is connected to a cooling intake circuit 26 feeding a hydraulic liquid cooling unit 27 which is connected to the auxiliary hydraulic reservoir 16 by a cooling return circuit 28. Once the construction vehicle 1 is assembled and almost ready for shipment, one of the last operations is the filling with a hydraulic liquid of the hydraulic power unit and all the hydraulic circuits equipments and actuators of the construction vehicle.

Therefore, the hydraulic reservoir 15, 16 are filled with the hydraulic liquid through a filling port 30 connected to the auxiliary hydraulic reservoir 16 as shown on FIG. 3. During this filling, the combustion engine is running at a low load for driving the hydraulic pump at a low discharge rate so as to eliminate all the air from the various hydraulic components and circuits. In order to accelerate this air draining and eliminate all the air bubbles from the hydraulic liquid, the roof 35 of the main hydraulic reservoir 15 is inclined at a predetermined angle α to the horizontal when the vehicle 1 rests on a horizontal ground. Accordingly, the air of the circuit 22 is connected to the main hydraulic reservoir in an upper part of the roof. In order to make sure that air bubbles do not stuck to the roof 35, the angle α is chosen to be preferably superior or equal to 3° and more preferably to be superior or equal to 5°. In order to make sure that the air draining is efficient, the main hydraulic reservoir 15 has, on the shown example but not necessarily, a general horizontal configuration, i.e. the length and width of the main hydraulic reservoir 15 are greater than the height of said main hydraulic reservoir 15. This allows to have a free surface of the hydraulic liquid within the main hydraulic reservoir as extended as possible in order to facilitate the air draining. It must be noted that a connection of the return cooling circuit 28 to the auxiliary hydraulic reservoir 16 accelerates the air draining. In order to guarantee that the air bubbles into the return hydraulic liquid are not sucked hack by the hydraulic pump 6, connection of the main return circuit to the main hydraulic reservoir is situated at a distance of the connection of the main intake circuit to the main hydraulic reservoir greater than 400 mm. After a running time of about an hour, it is considered that all the air has been drained from the hydraulic circuit and the hydraulic liquid quantity is completed up to a normal filling level L of the auxiliary hydraulic reservoir 16. The normal filling level L is controlled through a hydraulic liquid gauge 36 fitted on the auxiliary hydraulic reservoir 16. In order to make sure that the hydraulic pump 6 is always fed with hydraulic liquid and not sucking air even when the construction vehicle 1 is resting or working on slope and inclined ground, the auxiliary hydraulic reservoir 15 and the main hydraulic circuit 21 are designed so as to achieve a sufficient hydraulic liquid height H measured from an intake 37 of the hydraulic pump 6 to the normal filling level L. On the shown example but not necessarily, the hydraulic liquid height H is chosen to be greater than 500 mm, for example around 700 mm. In order to contribute to the hydraulic, liquid heights, the auxiliary hydraulic reservoir 15 is of general vertical design, i.e. height is greater than width. It must be noted that on the shown example the auxiliary hydraulic reservoir 16 is designed in order to allow some tolerance with the filling in order to avoid any hydraulic liquid spoiling when the hydraulic reservoir 15, 16 are filled or refilled.

It should be noted that an advantage of the split design of the hydraulic liquid holding unit is allowing to situate the main hydraulic reservoir 16 next or near to the hydraulic pump 6 and the hydraulic command unit 9 which allows a reduction of the length of the main intake circuit 23 and main return circuit 24 inducing a reduction of the friction losses and a better efficiency of the pump 6. For example, the main return circuit is designed to have length measured between an exit of the hydraulic filter 25 and the main hydraulic reservoir less than 700 mm. For the same purpose, on the shown example, the main intake circuit has a length measured between the pump intake 37 and the main hydraulic reservoir 15 being inferior or equal to 300 mm.

While the invention has been shown and described with reference to certain embodiments thereof, it would be understood by those skilled in the art that changes in form and details may be made therein without departing from the spirit and scope of the invention as defined in the appended claims.

1-20. (canceled)

21. A construction vehicle comprising:
a wheeled chassis supporting at least one work equipment hydraulically actuated;
a hydraulic power unit driving the work equipment comprising a hydraulic pump connected to an hydraulic liquid holding unit and to a hydraulic control unit distributing hydraulic power the work equipment;
a combustion engine driving the vehicle and the hydraulic pump;
a driver's compartment comprising a driver's floor;
the hydraulic liquid holding unit comprising:
a main hydraulic reservoir which is disposed on the chassis at a level lower than the driver's floor level and which is connected by a main intake circuit to the hydraulic pump and by a main return circuit to the hydraulic control unit; and
at least one auxiliary hydraulic reservoir which is disposed on the chassis at a level above the driver's floor level and which is connected to the main hydraulic reservoir by a main down circuit and by an air bleed circuit,
wherein the auxiliary hydraulic reservoir is situated in front of driver's compartment.

22. A construction vehicle according to claim 21, wherein the main hydraulic reservoir is situated under the driver's compartment.

23. A construction vehicle according to claim 21, wherein the chassis comprises two elongated frame members and the main hydraulic reservoir is situated between the two elongated frame members.

24. A construction vehicle according to claim 23, wherein the chassis comprises two front loader support posts, the auxiliary hydraulic reservoir being situated between the support posts.

25. A construction vehicle according to claim 21, wherein the main hydraulic reservoir comprises a roof which is inclined at a predetermined angle to the horizontal when the vehicle rests on a horizontal ground, the air bleed circuit being connected to the main hydraulic reservoir in an upper part of the roof.

26. A construction vehicle according to claim 25, wherein the predetermined angle is greater or equal to 3°.

27. A construction vehicle according to claim 25, wherein the main intake circuit is connected to the main hydraulic reservoir under a lower part of the roof.

28. A construction vehicle according to claim 25, wherein the roof has a maximal length and maximal width which both are greater than or equal to a maximum height of the main hydraulic reservoir.

29. A construction vehicle according to claim 21, wherein the main down circuit is connected to the main hydraulic reservoir above the connection of the main intake circuit to the main hydraulic reservoir.

30. A construction vehicle according to claim 21, wherein the main intake circuit is connected to the main hydraulic reservoir at a level upper that the level of a intake of the hydraulic pump.

31. A construction vehicle according to claim 21, wherein it comprises a hydraulic liquid height between a normal tilling level of the auxiliary hydraulic reservoir and an intake of the hydraulic pump, this hydraulic liquid height being greater than 500 mm.

32. A construction vehicle according to claim 21, wherein the hydraulic liquid holding unit has a capacity greater than or equal to a third of the total capacity of hydraulic liquid of the vehicle.

33. A construction vehicle according to claim 21, wherein the main hydraulic reservoir has a capacity greater than or equal to the volume of hydraulic liquid contained by the auxiliary hydraulic reservoir when it is filed up to a normal tilling level.

34. A construction vehicle according to claim 33, wherein the volume of hydraulic liquid contained by the auxiliary hydraulic reservoir when it is filed up to a normal filling level is greater than or equal to a sixth of the total normal capacity of hydraulic liquid of the vehicle.

35. A construction vehicle according to claim 32, wherein the main hydraulic reservoir has a capacity greater than or equal to a sixth of the total normal capacity of hydraulic liquid of the vehicle.

36. A construction vehicle according to claim 21, further comprising a hydraulic liquid cooling unit having a cooling intake circuit connected to the main return circuit and a cooling return circuit connected to the auxiliary hydraulic reservoir.

37. A construction vehicle according to claim 21, wherein the main return circuit has a length measured between an exit of a hydraulic filter and the main hydraulic reservoir less than 700 mm.

38. A construction vehicle according to claim 21, wherein the connection of the main return circuit to the main hydraulic reservoir is situated at a distance of the connection of the main intake circuit to the main hydraulic reservoir, the distance being greater than 400 mm.

39. A construction vehicle according to claim 21, wherein the main intake circuit has a length measured between a pump intake and the main hydraulic reservoir, the length being less than 500 mm.

40. A construction vehicle according to claim 21, wherein the main hydraulic reservoir is connected to the chassis by vibration absorbers.
